(19) United States
(12) Patent Application Publication
(10) Pub. No.: US 2026/0134379 A1
(43) Pub. Date: May 14, 2026

(54) DELIVERY SUPPORT DEVICE, DELIVERY SUPPORT METHOD, AND RECORDING MEDIUM

(71) Applicant: NEC Corporation, Tokyo (JP)

(72) Inventor: Saki ARUGA, Tokyo (JP)

(73) Assignee: NEC Corporation, Tokyo (JP)

(21) Appl. No.: 19/358,679

(22) Filed: Oct. 15, 2025

(30) Foreign Application Priority Data
Nov. 8, 2024 (JP) 2024-195854

(51) Int. Cl. G06Q 10/0832

(52) U.S. Cl. CPC G06Q 10/0832

(57) ABSTRACT

A delivery support device includes: a memory storing instructions; and at least one processor configured to execute the instructions to: determine a loading position of a package in a delivery means capable of loading packages in different temperature zones, based on information regarding an environment included in a delivery route for a time of delivery to a customer in a predetermined period; and output information regarding the determined loading position.

This application is based upon and claims the benefit of priority from Japanese patent application No. 2024-195854, filed on November 8, 2024, the disclosure of which is incorporated herein in its entirety by reference.

### TECHNICAL FIELD

### The present disclosure relates to a delivery support device and the like.

### BACKGROUND ART

For example, delivery is performed in which a truck travels around a plurality of delivery destinations, and at each delivery destination, a delivery person picks up a package addressed to each delivery destination on a cargo bed of the truck. The packages may sometimes be kept in various temperature zones. For example, JP 2017-057044 A describes managing an internal temperature of a heat-insulating box placed on a cargo bed of a vehicle.

### SUMMARY

Meanwhile, there is a case where packages in different temperature zones are delivered by a same delivery means. Even in such a case, each delivery person arranges, for example, where to load packages in the delivery means, as appropriate. In particular, in a case where packages in different temperature zones are delivered by a same delivery means, it may sometimes be difficult for the delivery person to arrange where to load each package.

An exemplary object of the present disclosure is to provide a delivery support device and the like that can facilitate determination of a loading position of a package on a delivery means when the package is delivered using the delivery means.

A delivery support device according to an aspect of the present disclosure includes

a determination means for determining a loading position of a package in a delivery means capable of loading packages in different temperature zones, based on information regarding an environment included in a delivery route for a time of delivery to a customer in a predetermined period, and

an output means for outputting information regarding the determined loading position.

A delivery support method according to an aspect of the present disclosure includes

determining, by at least one computer, a loading position of a package in a delivery means capable of loading packages in different temperature zones, based on information regarding an environment included in a delivery route for a time of delivery to a customer in a predetermined period, and

outputting, by the at least one computer, information regarding the determined loading position.

A program according to an aspect of the present disclosure causes at least one computer to execute

determining a loading position of a package in a delivery means capable of loading packages in different temperature zones, based on information regarding an environment included in a delivery route for a time of delivery to a customer in a predetermined period, and

outputting information regarding the determined loading position.

Each program may be stored in a non-transitory recording medium readable by the at least one computer.

According to the present disclosure, determination of a loading position of a package on a delivery means when the package is delivered using the delivery means can be facilitated.

### BRIEF DESCRIPTION OF THE DRAWINGS

FIG. 1 is an explanatory diagram illustrating an example of a delivery support system including a delivery support device;

FIG. 2 is a block diagram illustrating an exemplary configuration of the delivery support device;

FIG. 3 is an explanatory diagram illustrating an exemplary display on a terminal;

FIG. 4 is a flowchart illustrating an exemplary operation of the delivery support device;

FIG. 5 is a block diagram illustrating an exemplary configuration of a delivery support device;

FIG. 6 is a flowchart illustrating an exemplary operation of the delivery support device; and

FIG. 7 is an explanatory diagram illustrating an exemplary hardware configuration of a computer.

### EXAMPLE EMBODIMENT

Hereinafter, example embodiments of a delivery support device, a delivery support method, a program, and a non-transitory recording medium recording the program according to the present disclosure will be described in detail with reference to the drawings. The present example embodiments do not limit the disclosed technique.

### First Example Embodiment

In a first example embodiment, basic functions of a delivery support device will be described in detail with reference to the drawings.

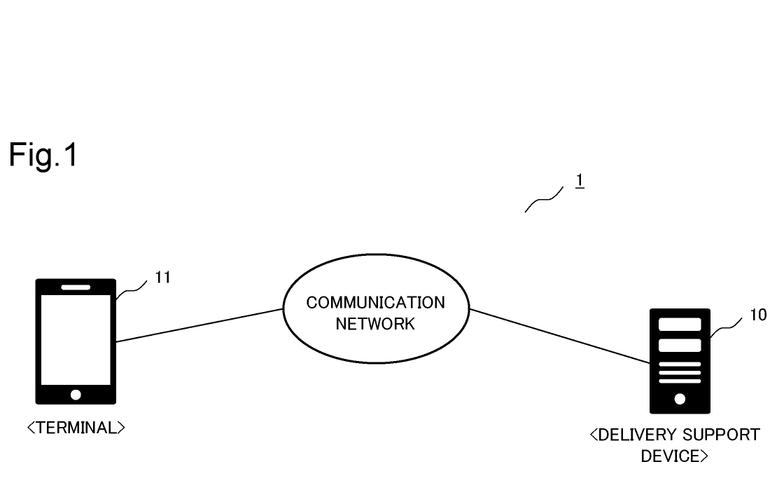

FIG. 1 is an explanatory diagram illustrating an example of a delivery support system including the delivery support device. The delivery support system 1 includes, for example, a delivery support device 10 and a terminal 11. The delivery support device 10 supports delivery of packages. Specifically, the delivery support system 1 supports arrangement of a position of a package in a delivery means that delivers packages in different temperature zones together. The delivery means can be loaded with packages in different temperature zones. The temperature zone here represents, for example, a temperature zone in which a package is retained. A method for expressing the temperature zones is not particularly limited, but the temperature zones will be described using three stages of room temperature, refrigeration, and freezing, for example.

Here, the delivery means is not particularly limited, and examples thereof include a vehicle, a ship, and an airplane. The vehicle is not particularly limited, and examples thereof include a train, an automobile, and a bicycle. For example, in some business entities such as a consumer’s cooperative, a common style of delivery is that a truck as a delivery means travels around a plurality of houses and a delivery person picks up a product addressed to each house on a cargo bed of the truck. Taking the consumer’s cooperative as an example, when a customer orders products in various temperature zones such as refrigerated products, room-temperature products, and frozen products several weeks before, the ordered products are delivered to the house together on a specified day of the week, or the like. In particular, in a business entity such as a consumer’s cooperative, the delivery route is substantially the same every week, and thus the delivery route is organized without waste. The product is not particularly limited, and examples thereof include food, daily necessities, furniture, and home electric appliances. In such a case, products in different temperature zones are packed and delivered in the same truck.

In some cases, a plurality of products in the same temperature zone may be packed in a bag, a container, or the like, and the bag or the container may be loaded onto the truck. The bag, the container, or the like may sometimes be collectively referred to as a holding container. Therefore, in each example embodiment, the unit for packages may be a unit of each product, may be a unit of the bag or the container in which one or more products are packed, or may be a combination thereof. Thus, the delivery support device 10 may determine a loading position in the delivery means in units of separate products, or may determine a loading position in units of containers. The acquisition of information regarding packages, such as the number of containers for each temperature zone, will be described using a second example embodiment.

The delivery support device 10 is connected to the terminal 11 and the like via a communication network. The terminal 11 may be, for example, a terminal 11 used by a delivery worker or a staff member who loads a package onto the delivery means. The terminal 11 may be an output destination device to which information from the delivery support device 10 is output, or may be an input source device that inputs information to the delivery support device 10. For example, the terminal 11 may be capable of outputting information from the delivery support device 10, or an application program capable of transmitting information to the delivery support device 10 may be installed in advance. For example, the terminal 11 may access a site of the delivery support device 10, which is a website, via a communication network NT. The type of the terminal 11 is not particularly limited, and examples thereof include a personal computer (PC), a smartphone, a tablet-type device, and a head mounted display (HMD). The number of terminals 11 is not particularly limited, and the terminals 11 may be prepared for each delivery worker.

The type of communication network such as a wired or wireless network is not particularly limited, and the communication network may be constituted by a plurality of communication networks. The configuration of the communication network by which the delivery support device 10 is connected to the terminal 11 and the like is not particularly limited.

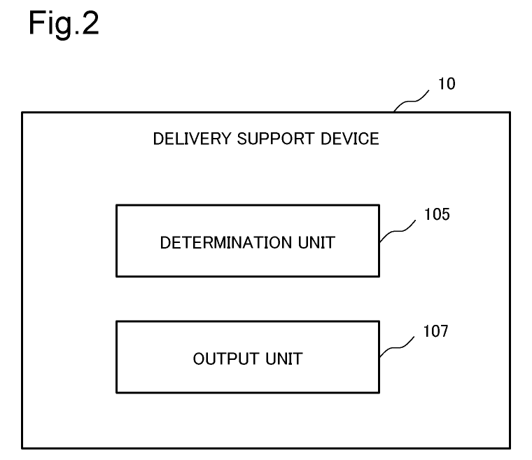

FIG. 2 is a block diagram illustrating an exemplary configuration of the delivery support device 10. The delivery support device 10 includes a determination unit 105 and an output unit 107.

The determination unit 105 determines a loading position of a package in a delivery means capable of loading packages in different temperature zones, based on information regarding an environment included in a delivery route for a time of delivery to a customer in a predetermined period. The predetermined period here is not particularly limited, and examples thereof include one year, half a year, three months, one month, and one season such as summer or winter. The information regarding the environment may be information about immediately preceding three months or the like, or may be information on a past year of the same time period. As described above, in a business entity such as a consumer’s cooperative, since the delivery route is substantially the same every week, it is expected that it is easy to acquire information regarding the environment.

The method for expressing the loading position is not particularly limited. For example, the loading position may be represented by, for example, numbers given to each of a plurality of areas obtained by partitioning the cargo bed of the delivery means by a predetermined size. The loading position may also be represented by, for example, a rear door side, a driver’s seat side, a far side of the cargo bed, an exit side of the cargo bed, a left side, a right side, a near side, a far side, a near right side, a near left side, a far right side, a far left side, and the like. The information regarding the environment may be information regarding how exposure to the sun is, according to the delivery time, or may be information regarding the temperature according to the delivery time. The information regarding how exposure to the sun is may be information regarding an amount of solar radiation measured by a solar radiation sensor installed in at least one of the inside and the outside of the delivery means. The information regarding how exposure to the sun is may be specified by information on weather conditions at a position where the delivery means stops, information on surrounding buildings, or the like. Examples of this specification will be described in the second example embodiment. The information regarding the temperature may be information regarding a temperature measured by a temperature sensor installed at least one of the inside and the outside of the delivery means. For example, each position inside the truck where the package is put may be measured by the temperature sensor, or each position outside the truck may be measured by the temperature sensor. The information regarding the temperature may be a numerical value itself of the temperature, or may be a temperature zone such as a high temperature, a low temperature, or a medium temperature, and is not particularly limited.

Specifically, for example, the determination unit 105 determines the loading position, based on the information regarding the environment and a temperature zone of the package, for example. More specifically, for example, in a case where the information regarding the environment includes information regarding how exposure to the sun is, the determination unit 105 determines the loading positions of packages in such a way that a package with a low temperature zone is loaded in a portion of the delivery means that is less likely to be exposed to the sun, based on the information regarding the environment and the temperature zones of the packages. The determination unit 105 may calculate statistics of the information regarding how exposure to the sun is at each position of the delivery means, based on the information regarding how exposure to the sun is in the predetermined period. The statistics are not particularly limited, and examples thereof include an average value, a median value, a mode value, a maximum value, and a minimum value. For example, the determination unit 105 determines the loading position of a package having a lowest temperature zone in a portion that is statistically less likely to be exposed to the sun in the predetermined period. Taking three temperature zones of room temperature, refrigeration, and freezing as an example, the determination unit 105 may determine the loading position of a frozen package in a portion that is statistically least likely to be exposed to the sun in the predetermined period. Taking three temperature zones of room temperature, refrigeration, and freezing as an example, the determination unit 105 may also determine the loading position of a room-temperature package in a portion that is statistically most likely to be exposed to the sun in the predetermined period.

Specifically, for example, in a case where the information regarding the environment includes information regarding the temperature, the determination unit 105 determines the loading positions of packages in such a way that a package with a low temperature zone is loaded in a portion related to a low temperature position. More specifically, for example, the determination unit 105 may calculate statistics of the information regarding the temperature at each position of the delivery means, based on the information regarding the temperature in the predetermined period. The statistics are not particularly limited, and examples thereof include an average value, a median value, a mode value, a maximum value, and a minimum value. For example, the determination unit 105 determines the loading positions of packages in such a way that a package with a low temperature zone is loaded in a portion related to a position having low statistics of the temperature in the predetermined period. Whether the temperature is low may be relatively evaluated or absolutely evaluated. For example, the determination unit 105 may specify a portion having a lower temperature than other portions, as a portion having a low temperature, or may specify a portion having a predetermined temperature or lower, as a portion having a low temperature. Specifically, for example, the determination unit 105 determines the loading position of a package with the lowest temperature zone in a portion related to a lowest temperature position. Taking freezing, refrigeration, and room temperature as an example, the determination unit 105 determines the loading position of a package of a frozen product in a portion related to a lowest temperature position. For example, in a case where a right side portion of the truck at a center of the cargo bed of the truck in a direction from the driver to the rear door has a lowest temperature, the determination unit 105 determines the loading position of the package of the frozen product in that portion.

The information regarding the temperature may include information regarding a temperature change. For example, the determination unit 105 may determine the loading position of a package of a frozen product in a portion having a low temperature and a small temperature change. For example, the determination unit 105 may determine the loading position of a package of a room-temperature product in a portion having a large temperature change.

The information regarding the temperature and the information regarding how exposure to the sun is may be used in combination. For example, the determination unit 105 may determine a place where the temperature is low and that is less likely to be exposed to the sun, as a loading position of a package with a lowest temperature zone.

The determination unit 105 may prioritize a package with a low temperature zone to determine the loading positions of packages. In a case where the packages are in units of containers, the determination unit 105 may determine the loading positions for each temperature zone of the container, instead of the loading positions of the individual containers.

For example, in a case where the number of containers with a room-temperature temperature zone is 10, the number of containers with a refrigeration temperature zone is 2, and the number of containers with a freezing temperature zone is 2, the determination unit 105 first determines, for example, two positions of the containers with the freezing temperature zone in a portion that is less likely to be exposed to the sun and where the temperature is low.

The output unit 107 outputs information regarding the determined loading positions. For example, the output unit 107 may present the determined loading positions as recommended loading positions. This allows a staff member who loads the packages to confirm the candidates for the loading positions. An output device as an output destination of the output unit 107 is not particularly limited, and examples thereof include a display device, a printing device, and a sound output device. The information regarding the loading positions may be information representing the loading positions for each package and is not particularly limited. The output device may be provided in the terminal 11. For example, the output unit 107 may display the information regarding the determined loading positions on the terminal 11.

The output unit 107 may also output the information regarding the loading positions and the information regarding the environment in association with each other. Specifically, for example, the output unit 107 may output which portion of the delivery means is likely to be exposed to the sun, which portion of the delivery means is a place with a low temperature, and the like together with the information regarding the loading positions.

For example, the output unit 107 may highlight the loading position of the package in a diagram representing the inside of the delivery means. For example, the output unit 107 displays a figure of the holding container to which the temperature zone is given, at the determined loading position in the diagram representing the inside of the delivery means.

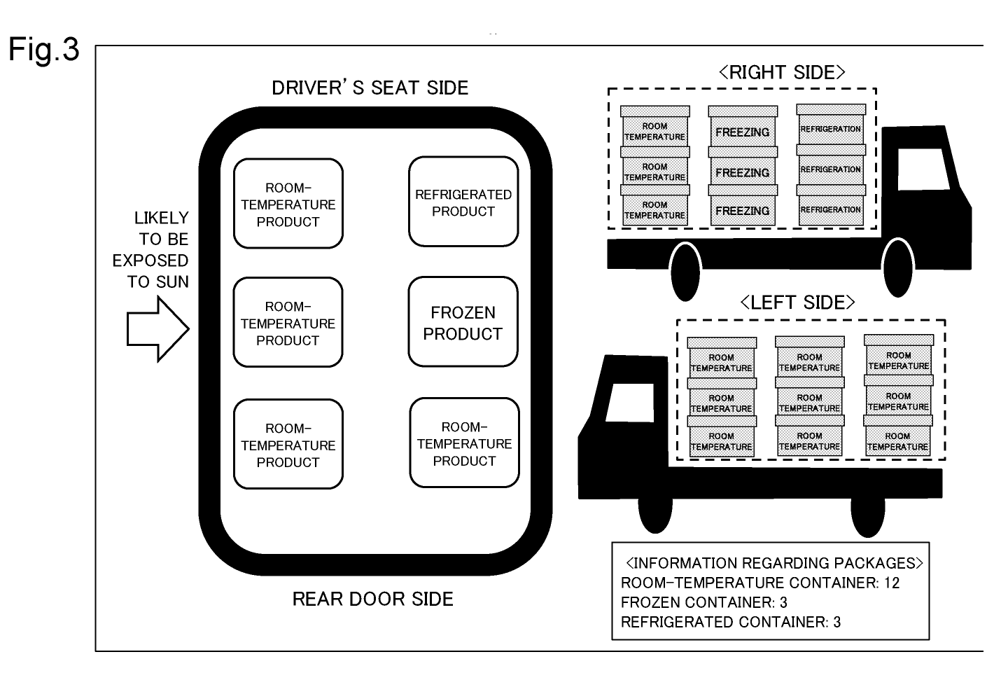

FIG. 3 is an explanatory diagram illustrating an exemplary display on the terminal 11. The output unit 107 displays the information regarding the determined loading positions on a touch panel display of the terminal 11. In FIG. 3, the number of containers to be loaded onto the truck is 18. The terminal 11 displays figures of packages with temperature zones labeled in a diagram imitating the truck. A portion that is likely to be exposed to the sun is also displayed on the terminal 11.

According to FIG. 3, for example, it is recommended to load three frozen containers in a center portion on the right side. According to FIG. 3, for example, it is recommended to load three refrigerated containers in a driver’s seat-side portion on the right side. According to FIG. 3, for example, it is recommended to load three room-temperature containers on a rear door-side portion on the right side. According to FIG. 3, for example, it is recommended to load nine room-temperature containers on the left side.

### Flowchart

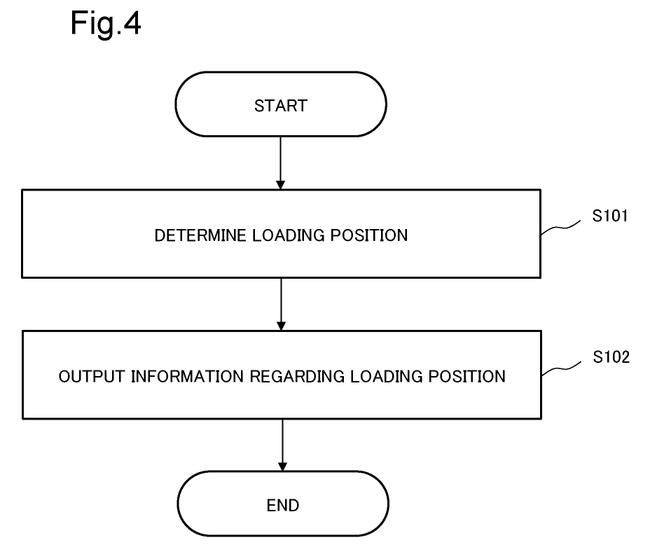

FIG. 4 is a flowchart illustrating an exemplary operation of the delivery support device 10. The determination unit 105 determines the loading positions of packages, based on the information regarding the environment (step S101). The output unit 107 outputs the information regarding the loading positions (step S102). Then, the delivery support device 10 ends a series of processes illustrated in FIG. 4.

As described above, in the first example embodiment, the delivery support device 10 determines the loading positions of packages, based on the information regarding the environment. The delivery support device 10 outputs the information regarding the loading positions. This can facilitate determination of the loading position of a package on the delivery means. The delivery support device 10 can also determine the loading positions according to the environments in each delivery route. The burden on the delivery person is reduced, and the delivery efficiency can be improved. Consequently, the delivery support device 10 can improve the quality maintenance for packages as well.

### Second Example Embodiment

A second example embodiment will be described in detail with reference to the drawings. In the second example embodiment, an example of specifying the information regarding how exposure to the sun is, included in the information regarding the environment will be described. Hereinafter, the description of content that is duplicate of the description above will be omitted to the extent that description of the second example embodiment is not unclear.

Since an example of the delivery support system including the delivery support device can be the same as the example illustrated in FIG. 1, a delivery support device 20 may be interpreted as a substitute for the delivery support device 10 illustrated in FIG. 1, and the description of the example of the delivery support system including the delivery support device 20 will be omitted.

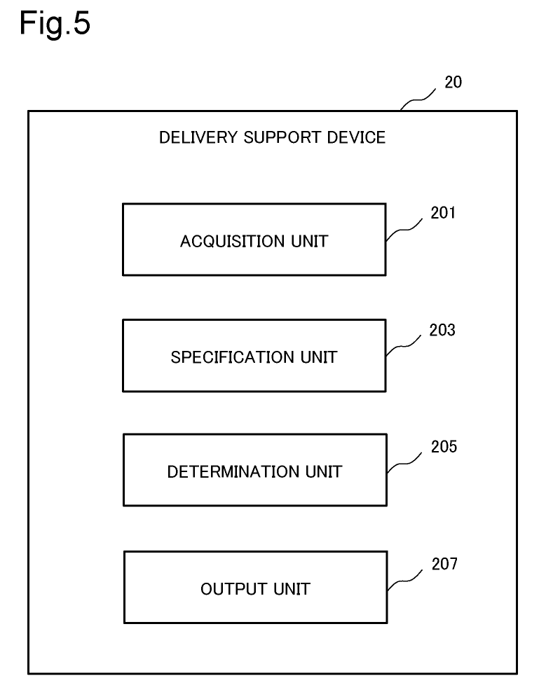

FIG. 5 is a block diagram illustrating an exemplary configuration of the delivery support device. The delivery support device 20 includes an acquisition unit 201, a specification unit 203, a determination unit 205, and an output unit 207.

The determination unit 205 has the function of the determination unit 105 illustrated in FIG. 2 as a basic function. The output unit 207 has the function of the output unit 107 illustrated in FIG. 2 as a basic function.

The acquisition unit 201 acquires information regarding a package to be loaded onto a delivery means. The information regarding a package may include information regarding temperature zones for each package. In a case where the unit for packages is a container, the information regarding packages may include information regarding the sizes and the number of containers for each temperature zone. If the sizes of the containers are all the same, the information regarding packages may be information regarding the number of containers for each temperature zone.

The acquisition unit 201 may accept an input of the information regarding packages from a staff member operating the terminal 11. More specifically, for example, the acquisition unit 201 may accept an input of the number of containers for each temperature zone via the terminal 11.

The acquisition unit 201 may also acquire the information regarding packages from an image of the packages captured by the terminal 11. Specifically, for example, after a product is packed in a container, a staff member images the container to be loaded onto the delivery means, using an imaging device provided in the terminal 11. The acquisition unit 201 acquires the image captured by the imaging device provided in the terminal 11 from the terminal 11. The acquisition unit 201 may acquire the number of containers for each temperature zone from the captured image as the information regarding packages.

The acquisition unit 201 may acquire the information regarding packages predicted based on order information from the customer scheduled to be delivered using the delivery means. The acquisition unit 201 may acquire the information regarding packages by performing prediction, or the acquisition unit 201 may acquire the information regarding packages obtained by prediction performed by another device, from the another device.

The acquisition unit 201 may also acquire information regarding an environment in a predetermined period. As described above, the information regarding the environment may include information regarding how exposure to the sun is and information regarding a temperature.

The information regarding how exposure to the sun is may be specified. Therefore, first, the acquisition unit 201 may acquire air temperature information, weather information, and the like at each position included in a delivery route in the predetermined period. Specifically, for example, the acquisition unit 201 may acquire the air temperature information and the weather information at each position included in the delivery route in the predetermined period from a meteorological forecast system via a communication network.

For example, the specification unit 203 specifies the information regarding how exposure to the sun is, based on information on surrounding buildings specified from surrounding map information including at least one of a position of a parking lot where the delivery means stops and a position where the delivery means stops. For example, the position of a parking lot where the delivery means stops and the position where the delivery means stops may be specified according to the delivery route or may be specified by positioning by a global positioning system (GPS) mounted on the delivery means. For example, the specification unit 203 may also specify the information regarding how exposure to the sun is in the stopped delivery means, based on a direction in which the delivery means is facing. In more detail, for example, the acquisition unit 201 may acquire the air temperature information, the weather information, and the like, and the specification unit 203 may specify the information regarding how exposure to the sun is at each position of the delivery means, based on a direction in which the delivery means is facing, the time of day when the delivery means stops, and the temperature information and the weather information. The direction in which the delivery means is facing may be specified by a gyro sensor, an in-vehicle compass, or the like installed in the delivery means.

The information regarding the environment in the predetermined period can be stored in a database or the like as appropriate.

The determination unit 205 determines the loading position of a package as described in the first example embodiment, based on the information regarding the environment and the information regarding the package.

For example, the determination unit 205 may determine the loading position of a package, based on information regarding an environment obtained by excluding information regarding an environment at the time of disaster from the information regarding the environment in the predetermined period. The disaster here is, for example, adverse weather conditions such as heavy rain or a typhoon. For example, the determination unit 205 excludes the information regarding the environment at the time of disaster from the information regarding the environment in the predetermined period, based on the weather information acquired by the acquisition unit 201. The determination unit 205 may determine the loading position of a package, based on the information regarding the environment after the exclusion.

The timing at which the determination unit 205 excludes the information regarding the environment at the time of disaster may be a timing at which each piece of the information regarding the environment is stored in the database, or a timing at which the loading position of the package is determined, and is not particularly limited. For example, in a case where the exclusion is performed at the timing of storing each piece of the information regarding the environment in the database, it is sufficient for the determination unit 205 to store the information regarding the environment after the exclusion in the database.

In a case where the specification unit 203 specifies the information regarding how exposure to the sun is, the specification unit 203 may specify the information regarding how exposure to the sun is, apart from the time of disaster.

In a case where there is a plurality of delivery destinations, the determination unit 205 may determine the loading positions of packages, further based on a delivery order of the packages. For example, the determination unit 205 determines the loading positions of the packages, based on the information regarding how exposure to the sun is and the delivery order of the packages. More specifically, for example, the determination unit 205 determines the loading position of a container that has a lowest temperature zone and is earlier in the delivery order, to a position that is less likely to be exposed to the sun and at which it is easy to take out the container, based on the information regarding how exposure to the sun is and the delivery order of the packages. In FIG. 3, for example, the determination unit 205 determines the loading position of a frozen container to be delivered early, to be a center on the right side, which is least likely to be exposed to the sun, at an uppermost stage, where it is most easy to take out the container in the center on the right side. This allows the delivery support device 20 to improve the delivery efficiency by determining the loading positions according to the temperature zones of the packages and the order of the delivery destinations.

As described in the first example embodiment, the output unit 207 outputs the information regarding the loading position determined by the determination unit 205.

### Flowchart

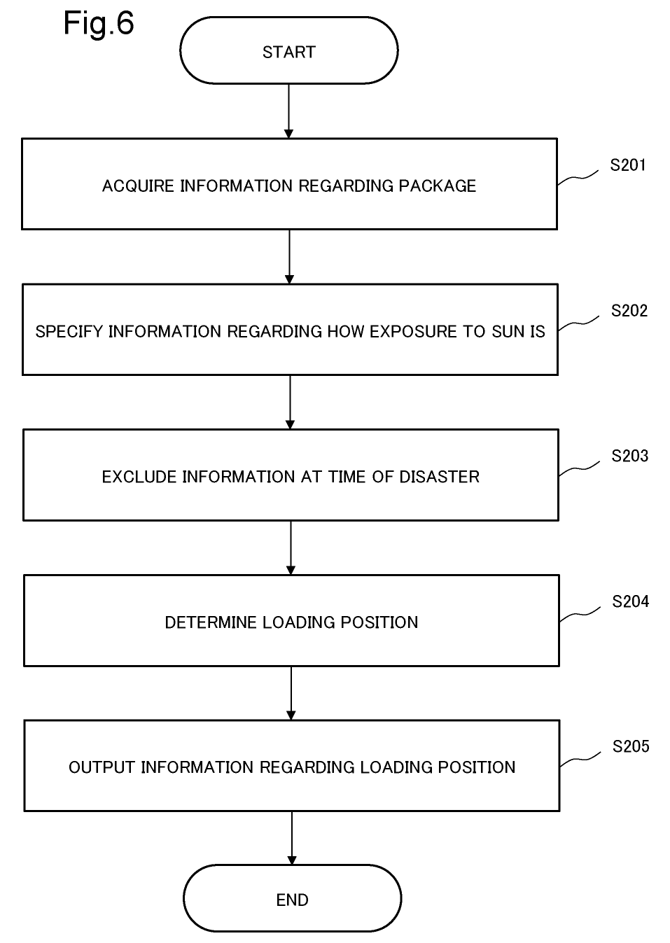

FIG. 6 is a flowchart illustrating an exemplary operation of the delivery support device 20. The acquisition unit 201 acquires the information regarding a package (step S201). Next, the specification unit 203 specifies the information regarding how exposure to the sun is in the predetermined period (step S202).

The determination unit 205 excludes the information at the time of disaster from the information regarding how exposure to the sun is in the predetermined period (step S203). Then, the determination unit 205 determines the loading position of the package, based on the information regarding how exposure to the sun is, after the exclusion (step S204). The output unit 207 outputs the information regarding the loading position of the package determined by the determination unit 205 (step S205), and the delivery support device 20 ends the series of processes illustrated in FIG. 6.

As described above, in the second example embodiment, the delivery support device 20 specifies the information regarding how exposure to the sun is, based on the information on buildings around a position of a parking lot where the delivery means stops or a position where the delivery means stops specified from the surrounding map information including those positions. In more detail, the delivery support device 20 specifies the information regarding how exposure to the sun is in the stopped delivery means, based on a direction in which the delivery means is facing. This allows the delivery support device 20 to specify how exposure to the sun is, in consideration of surrounding buildings. Accordingly, the delivery support device 20 can improve the quality maintenance for the package.

Thus, the description of the example embodiments has ended. The example embodiments are not limited to the examples described above and can be variously changed. For example, the example embodiments may be used in a modified manner.

The configurations of the delivery support devices 10 and 20 are not particularly limited. For example, the functional units of the delivery support device 10 or 20 may be implemented by one device. Alternatively, for example, the functional units or databases of the delivery support device 10 or 20 may be implemented by different devices from each other and may be configured as a system. For example, the functional units of the delivery support device 10 or 20 may be constituted by a plurality of devices. For example, a system including a database server including each database and a device including each functional unit may be implemented. A system including a device including a part of the functional units of the delivery support device 10 or 20 and a device including another part of the functional units of the delivery support device 10 or 20 may be implemented. The number of devices is not particularly limited.

The various sorts of information are an example and may further include other information or may not include some information. The user interface in each example embodiment is an example, and various changes can be made. The process of generating information or the like to be displayed on the terminal 11 may be performed by the output units 107 and 207. This process may be performed by the terminal 11. That is, the terminal 11 may generate screen information to be displayed on the terminal 11, based on the data received from the delivery support device 10 or 20, and display a screen, based on the screen information.

### Exemplary Hardware Configuration of Computer

Next, an exemplary hardware configuration in a case where each device such as the delivery support devices 10 and 20 and the terminal 11 is implemented by a computer will be described.

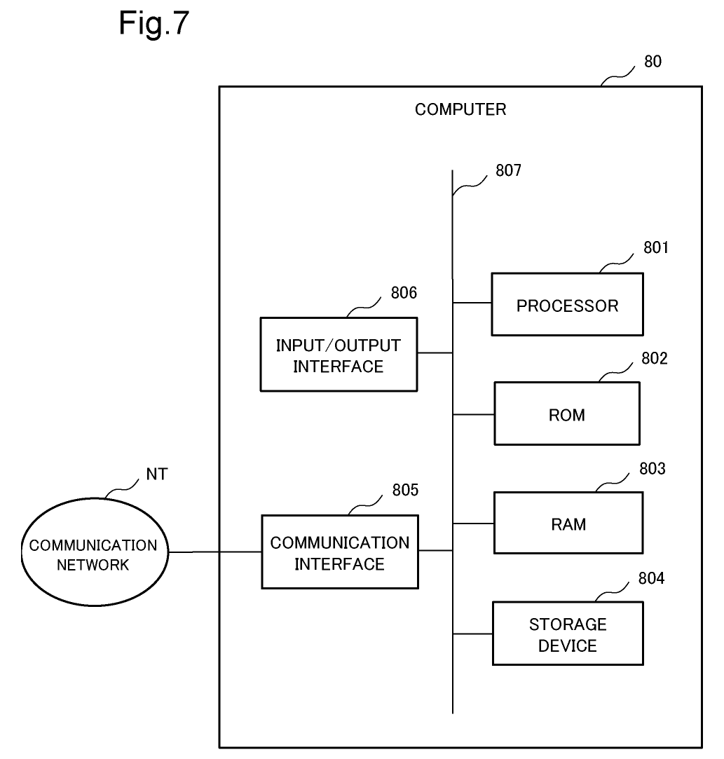

FIG. 7 is an explanatory diagram illustrating an exemplary hardware configuration of a computer. For example, some or all of the devices can also be implemented using any combination of a computer 80 as illustrated in FIG. 7 and a program.

The computer 80 includes, for example, a processor 801, a read only memory (ROM) 802, a random access memory (RAM) 803, and a storage device 804. The computer 80 also includes a communication interface 805 and an input/output interface 806. The constituents are connected to each other via a bus 807, for example. The number of constituents is not particularly limited, and one or more constituents are provided.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited.

The computer 80 includes the ROM 802, the RAM 803, the storage device 804, and the like. Examples of the storage device 804 include a semiconductor memory such as a flash memory, a hard disk drive (HDD), and a solid state drive (SSD). For example, the storage device 804 stores an operating system (OS) program, an application program, a program according to each example embodiment, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various sorts of programs via the communication network NT. The processor 801 functions as a part or the whole of the computer 80. The processor 801 may execute the processes or instructions in the flowcharts illustrated in the drawings, based on the program.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 7. The computer 80 may include a component other than those illustrated in FIG. 7. For example, the computer 80 may include a drive device. The processor 801 may read a program or data stored in a recording medium attached to a drive device or the like into the RAM 803. Examples of the non-transitory tangible recording medium include an optical disc, a flexible disk, a magneto-optical disc, and a universal serial bus (USB) memory.

The computer 80 may include various sorts of sensors (not illustrated). The type of the sensor is not particularly limited. The computer 80 may include an imaging device capable of capturing images and videos.

Thus, the description of the hardware configuration of each device has ended. The method for implementing each device has various modifications. For example, each device may be implemented by any combination of a computer and a program different for each component. A plurality of components included in each device may be implemented by any combination of one computer and a program.

Some or all of the components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be disposed in a centralized manner or in a distributed manner.

The delivery support method described in each example embodiment may be executed and implemented by a computer such as the delivery support device 10.

Each program described in each example embodiment is recorded in a computer-readable recording medium such as an HDD, an SSD, a flexible disk, an optical disc, a magneto-optical disc, or a USB memory. Each program is read from the recording medium and executed by the computer. Each program may be distributed via the communication network NT.

The function of each component of the delivery support device 10 described above in each example embodiment may be implemented by dedicated hardware such as a computer. Alternatively, each component may be implemented by software. Alternatively, each component may be implemented by a combination of hardware and software.

While the present disclosure has been particularly shown and described with reference to example embodiments thereof, the present disclosure is not limited to these example embodiments. The forms and details of the present disclosure may include example embodiments to which various changes that can be understood by those of ordinary skill in the art without departing from the spirit and scope of the present disclosure are applied. The present disclosure may include example embodiments in which the matters described in the present specification are appropriately combined or replaced, as necessary. For example, the matters described using a specific example embodiment can be applied to other example embodiments as long as no contradiction occurs. For example, although the plurality of operations is described in order in the form of a flowchart, the described order does not limit the order in which the plurality of operations is executed. Therefore, when each example embodiment is carried out, the order of the plurality of operations can be changed within a range that does not interfere with the content.

Some or all of the example embodiments described above may also be described as the following Supplementary Notes. However, some or all of the example embodiments described above are not limited to the following.

### Supplementary Note 1

A delivery support device including:

a determination means for determining a loading position of a package in a delivery means capable of loading packages in different temperature zones, based on information regarding an environment included in a delivery route for a time of delivery to a customer in a predetermined period; and

an output means for outputting information regarding the determined loading position.

### Supplementary Note 2

The delivery support device according to Supplementary Note 1, in which

the determination means determines the loading position, based on the information regarding the environment and a temperature zone of the package.

### Supplementary Note 3

The delivery support device according to supplementary note 1 or 2, in which

the information regarding the environment includes information regarding how exposure to the sun is in the delivery means, the delivery support device further including

a specification means for specifying the information regarding how the exposure to the sun is, based on information on a building around a position of a parking lot where the delivery means stops or a position where the delivery means stops, the information on the building being specified from surrounding map information including the position.

### Supplementary Note 4

The delivery support device according to Supplementary Note 3, in which

the specification means specifies the information regarding how the exposure to the sun is in the stopped delivery means, based on a direction in which the delivery means is facing.

### Supplementary Note 5

The delivery support device according to any one of Supplementary Notes 1 to 4, in which

the information regarding the environment includes information regarding how exposure to the sun is in the delivery means, and

the determination means determines the loading position in such a way that a package with a low temperature zone is loaded in a portion of the delivery means that is less likely to be exposed to the sun.

### Supplementary Note 6

The delivery support device according to Supplementary Note 5, in which

how the exposure to the sun is at each position of the delivery means is specified by an amount of solar radiation measured by a solar radiation sensor attached to at least one of an outside and an inside of the delivery means.

### Supplementary Note 7

The delivery support device according to any one of Supplementary Notes 1 to 6, in which

the information regarding the environment includes information regarding a temperature at each position of the delivery means, and

the determination means determines the loading position in such a way that a package with a low temperature zone is loaded in a portion related to a position having a low statistic of the temperature in the predetermined period.

### Supplementary Note 8

The delivery support device according to Supplementary Note 7, in which

the temperature at each position of the delivery means is a temperature measured by a temperature sensor attached to at least one of an outside and an inside of the delivery means.

### Supplementary Note 9

The delivery support device according to any one of Supplementary Notes 1 to 8, in which

the determination means determines the loading position, based on information regarding an environment obtained by excluding information regarding an environment at a time of disaster from the information regarding the environment in the predetermined period.

### Supplementary Note 10

The delivery support device according to any one of Supplementary Notes 1 to 9, in which

the package is a holding container that contains a product ordered by a customer.

### Supplementary Note 11

A delivery support method including:

determining, by at least one computer, a loading position of a package in a delivery means capable of loading packages in different temperature zones, based on information regarding an environment included in a delivery route for a time of delivery to a customer in a predetermined period; and

outputting, by the at least one computer, information regarding the determined loading position.

### Supplementary Note 12

A program for causing at least one computer to execute:

determining a loading position of a package in a delivery means capable of loading packages in different temperature zones, based on information regarding an environment included in a delivery route for a time of delivery to a customer in a predetermined period; and

outputting information regarding the determined loading position.

### Supplementary Note 13

A non-transitory recording medium readable by at least one computer that records a program for causing the at least one computer to execute:

determining a loading position of a package in a delivery means capable of loading packages in different temperature zones, based on information regarding an environment included in a delivery route for a time of delivery to a customer in a predetermined period; and

outputting information regarding the determined loading position.

Some or all of the configurations described in Supplementary Notes 2 to 10 subordinate to the above-described Supplementary Note 1 can also be subordinate to Supplementary Notes 11, 12, and 13 with a subordinate relationship similar to that of Supplementary Notes 2 to 10. Furthermore, some or all of the configurations described as the Supplementary Notes can be similarly subordinate to not only the Supplementary Notes 1, 11, 12, and 13, but also various pieces of hardware and software, and a variety of recording means for recording software, or a system without departing from the above-described example embodiments.

1. A delivery support device comprising:
a memory storing instructions; and
at least one processor configured to execute the instructions to:
determine a loading position of a package in a delivery means capable of loading packages in different temperature zones, based on information regarding an environment included in a delivery route for a time of delivery to a customer in a predetermined period; and
output information regarding the determined loading position.

2. The delivery support device according to claim 1, wherein the at least one processor is further configured to execute the instructions to:
determine the loading position, based on the information regarding the environment and a temperature zone of the package.

3. The delivery support device according to claim 1, wherein
the information regarding the environment includes information regarding how exposure to the sun is in the delivery means, and the at least one processor is further configured to execute the instructions to:
specify the information regarding how the exposure to the sun is, based on information on a building around a position of a parking lot where the delivery means stops or a position where the delivery means stops, the information on the building being specified from surrounding map information including the position.

4. The delivery support device according to claim 3, wherein the at least one processor is further configured to execute the instructions to:
specify the information regarding how the exposure to the sun is in the stopped delivery means, based on a direction in which the delivery means is facing.

5. The delivery support device according to claim 1, wherein
the information regarding the environment includes information regarding how exposure to the sun is in the delivery means, and the at least one processor is further configured to execute the instructions to:
determine the loading position in such a way that a package with a low temperature zone is loaded in a portion of the delivery means that is less likely to be exposed to the sun.

6. The delivery support device according to claim 1, wherein
the information regarding the environment includes information regarding a temperature at each position of the delivery means, and the at least one processor is further configured to execute the instructions to:
determine the loading position in such a way that a package with a low temperature zone is loaded in a portion related to a position having a low statistic of the temperature in the predetermined period.

7. The delivery support device according to claim 6, wherein
the temperature at each position of the delivery means is measured by a temperature sensor attached to at least one of an outside and an inside of the delivery means.

8. The delivery support device according to claim 1, wherein the at least one processor is further configured to execute the instructions to:
determine the loading position, based on information regarding an environment obtained by excluding information regarding an environment at a time of disaster from the information regarding the environment in the predetermined period.

9. A delivery support method comprising:
determining, by at least one computer, a loading position of a package in a delivery means capable of loading packages in different temperature zones, based on information regarding an environment included in a delivery route for a time of delivery to a customer in a predetermined period; and
outputting, by the at least one computer, information regarding the determined loading position.

10. A non-transitory recording medium readable by at least one computer that records a program for causing the at least one computer to execute:
determining a loading position of a package in a delivery means capable of loading packages in different temperature zones, based on information regarding an environment included in a delivery route for a time of delivery to a customer in a predetermined period; and
outputting information regarding the determined loading position.
